(19) United States
(12) Patent Application Publication
(10) Pub. No.: US 2011/0156621 A1
(43) Pub. Date: Jun. 30, 2011

(54) RAIL VEHICLE WHICH HAS A PERMANENT-MAGNET SYNCHRONOUS MOTOR AS TRACTION MOTOR

(75) Inventor: Andreas Schaefer-Enkeler, Roettenbach (DE)

(73) Assignee: SIEMENS AKTIENGESELLSCHAFT, München (DE)

(21) Appl. No.: 13/054,685

(22) PCT Filed: Jul. 2, 2009
(86) PCT No.: PCT/EP2009/058299

§ 371 Date: Feb. 4, 2011

(30) Foreign Application Priority Data
Jul. 17, 2008 (DE) 10 2008 033 639.4

(51) Int. Cl. H02P 3/12

(52) U.S. Cl. 318/380

(57) ABSTRACT

A rail vehicle has a permanent-magnet synchronous motor as its traction motor. A switching apparatus is arranged between a converter and the traction motor, connects the traction motor to the converter in the driving mode and connects the traction motor to at least one braking resistance during generator operation of the traction motor. The switching apparatus can be operated pneumatically and is for this purpose connected to a main air control line of a compressed-air braking system. In the driving mode, when the pressure in the main air control line is greater than a threshold value, the traction motor is connected to the converter. For braking, when the pressure in the main air control line is less than the threshold value, the traction motor is connected to the at least one braking resistance.

The invention relates to a rail vehicle which has a permanent-magnet synchronous motor as a traction motor, wherein a switching apparatus is arranged between a converter and the traction motor, connects the traction motor to the converter during driving operation and connects the traction motor to at least one braking resistance during generator operation of the traction motor.

A rail vehicle such as this is known from DE 10 2004 032 680 A1. In this case, the vehicle with the motor brake is braked by the rotor of the permanent-magnet synchronous machine rotating as long as the vehicle is continuing to move. In the process, a voltage is induced in the stator windings. Braking resistances which are arranged in the stator circuit then produce a braking torque, which acts on the rotor.

When a vehicle such as this is being towed, in which case no external power supply is any longer generally provided, the vehicle is braked continuously by the motor brake. Until now, it has been possible to prevent this only by electrically completely disconnecting the traction motors during towing. However, this then means that the vehicle being towed can no longer be braked.

The invention is based on the object of specifying a rail vehicle which has a permanent-magnet synchronous motor as a traction motor, which on the one hand can be towed without having to electrically disconnect the traction motor, and which, furthermore, can also be braked while being towed.

According to the invention, the object is achieved in that the switching apparatus can be operated pneumatically and for this purpose is connected to a main air control line of a compressed-air braking installation, in that during driving operation, when the pressure in the main air control line is greater than a threshold value, the traction motor is connected to the converter, and in that, for braking, when the pressure in the main air control line is less than the threshold value, the traction motor is connected to the at least one braking resistance.

During towing, the main air control line is supplied with compressed air from the towing vehicle.

Since the switching apparatus can be operated pneumatically and the main air control line of a compressed-air braking installation is used for operation, this results in the advantage that the permanent-magnet synchronous motor is connected to the at least one braking resistance when the compressed-air braking installation is also carrying out braking after the pressure in the main air control line has fallen below the threshold value. On the one hand, this prevents there always being a connection between the traction motor and the braking resistance during towing, which would lead to continuous braking, while on the other hand ensuring that whenever the compressed-air braking installation of the towing vehicle is used for braking, the motor brake of the vehicle being towed acts by connecting the traction motor to the at least one braking resistance via the switching apparatus. The vehicle being towed is therefore advantageously braked even when it is disconnected from an external power supply, together with the towing vehicle. The motor brake comprising a permanent-magnet synchronous motor and at least one braking resistance in the vehicle being towed supports the compressed-air braking installation.

By way of example, the switching apparatus has a manual switch or a connection for a mechanical linkage, by means of which the traction motor can be permanently disconnected from the at least one braking resistance. It is therefore possible to provide for the vehicle being towed never being braked, as required.

For example, the pneumatically operable switching apparatus is connected to a pressure indication which indicates whether the pressure threshold value has been undershot and the traction motor is therefore connected to the at least one braking resistance. This makes it possible to identify whether the motor brake in the vehicle being towed is or is not in operation.

According to another example, the switching apparatus is connected to an indicator which indicates whether there is an electrical connection between the traction motor and the at least one braking resistance. This also makes it possible to tell whether the motor brake of the vehicle being towed is or is not in operation.

According to one alternative example, the switching apparatus is connected to another indicator which operates electrically or pneumatically and indicates whether the at least one braking resistance has been permanently disconnected from the traction motor. This also indicates whether the motor brake is or is not in operation.

A normal pressure in the main air control line is about 5 bar. A suitable pressure threshold value, below which the traction motor is connected to the at least one braking resistance, is 3.5 bar.

The invention results in particular in the advantage that a rail vehicle which has a permanent-magnet synchronous motor as a traction motor can be towed in a simple manner and, furthermore, can be braked even while being towed.

1-5. (canceled)

6. A rail vehicle, comprising:
a permanent-magnet synchronous motor forming a traction motor of the rail vehicle, to be selectively operated in a driving operation for driving the rail vehicle and in a generator operation for braking the rail vehicle;
a switching apparatus connected between a converter and said traction motor, said switching apparatus connecting said traction motor to said converter during the driving operation of said traction motor and connecting said traction motor to at least one braking resistance during the generator operation of said traction motor;
a main air control line of a compressed-air braking installation connected to said switching apparatus for pneumatically operating said switching apparatus, wherein:
during the driving operation, when a pressure in said main air control line is greater than a threshold value, said traction motor is connected to said converter; and
for braking, when the pressure in said main air control line is less than the threshold value, said traction motor is connected to the at least one braking resistance.

7. The rail vehicle according to claim 6, wherein said switching apparatus includes a manual switch or a connection for a mechanical linkage, for enabling said traction motor to be permanently disconnected from the at least one braking resistance.

8. The rail vehicle according to claim 6, which comprises a pressure indicator connected to said pneumatically operable switching apparatus, said pressure indicator indicating whether the pressure threshold value has been undershot and said traction motor is therefore connected to the at least one braking resistance.

9. The rail vehicle according to claim 6, which comprises an indicator connected to said switching apparatus for indicating whether there is an electrical connection between said traction motor and the at least one braking resistance.

10. The rail vehicle according to claim 6, which comprises an electrically or pneumatically operating indicator connected to said switching apparatus for indicating whether the at least one braking resistance has been permanently disconnected from said traction motor.

11. The rail vehicle according to claim 6, which further comprises:
a pressure indicator connected to said pneumatically operable switching apparatus, said pressure indicator indicating whether the pressure threshold value has been undershot and said traction motor is therefore connected to the at least one braking resistance;
a further indicator connected to said switching apparatus for indicating whether there is an electrical connection between said traction motor and the at least one braking resistance; and
an electrically or pneumatically operating indicator connected to said switching apparatus for indicating whether the at least one braking resistance has been permanently disconnected from said traction motor.
